(19) United States
(12) Patent Application Publication
(10) Pub. No.: US 2001/0020632 A1
(43) Pub. Date: Sep. 13, 2001

(54) Cap for a wet wipe dispensing container

(76) Inventors: Alvaro Augusto Freitas De Oliveira, Sao Jose dos Campos (BR); Waldir Borges Alves, Sao Jose dos Campos (BR)

Correspondence Address: Philip S. Johnson, Esq., Johnson & Johnson, One Johnson & Johnson Plaza, New Brunswick, NJ, 08933-7003, US

(21) Appl. No.: 09/733,369

(22) Filed: Dec. 8, 2000

(30) Foreign Application Priority Data
Dec. 8, 1999 (BR) PI 9905712-3

(51) Int. Cl. B26F 3/02

(52) U.S. Cl. 225/106; 225/93; 225/20; 225/23

(57) ABSTRACT

A cap for a wet wipe dispensing container, comprising an upper wall (22) provider with a window (25), through which is extracted the continuous wipe strip and whose contour is extended, at last on one of the sides, by a narrow slot (26) for introducing and retaining the wipe strip, said upper wall (22) carrying, externally, a cutting blade (30) spaced away from the narrow slot (26), for cutting the transversal extension of the continuous wipe strip when it is pressed against said cutting blade by the user.

### FIELD OF THE INVENTION

The present invention refers, in general, to a dispensing container for a strip of wet and usually perfumed wipes and, more particularly, to a cap to be applied to this type of container and provided with means for releasing and cutting extensions of said strip of wet paper wipes stored within said container.

### BACKGROUND OF THE INVENTION

Wet wipe dispensing containers are well known in the art and comprise a tubular container, which may be prismatic or in the form of a bag, carrying an end piece, which may be detachable or non-detachable, defining a cap provided with means for controllably releasing wipe strip extensions which are pulled out from the container by the user. These controlled releasing means for the wipe strip comprise a window, through which the wipe strip is taken and which is usually protected by an overcap, and which is constructed in such a way as to exert a certain restriction or brake to the exit of the wipes, allowing to protect the contents of the container against drying and also promote the cutting of the wipe strip when the user exerts, upon the extension already extracted from the container, a certain abrupt pulling force, which is preferably slightly transversal in relation to the window axis.

A known window construction for extracting the wipe strip comprises a pair of cross shaped cuts provided on an upper wall of the cap, defining cap portions which are slightly flexible and allow the wipe strip to be pulled through these cuts out from the container, this operation being continuously braked by the elastic deformation force of the upper wall portions defined between each two adjacent cut portions.

While permitting an adequate protection to the wet wipe strip stored inside the container, as well as a controlled withdrawal of said strip, in order to lead to the relatively easy cutting or separation of the desired wipes to be obtained, these known constructive solutions have the inconvenience of cutting the wipe strip too close to the window plane, leaving only a short extension or no extension at all of the wipe strip outside the container, in order to serve as a grasping portion to the user when he wishes to obtain another wipe extension. In many cases, the wipe extension remaining outside the window is insufficient to be grasped by the user's fingers, who has to remove the cap from the container and manually force the wipe strip through the window and then replace the cap in its position, in order to restart the extracting and cutting operations of the wipe strip. This operation, besides being laborious, requires the user to manipulate the contents of the container, contaminating in a higher or lesser degree the wipes stored therewith, which wipes, without the cap being removed, would be adequately protected, being only manipulated when taken out from the cap through the window.

In these known solutions, the window is the only element of the cap acting on the wipe strip for allowing the latter to be torn along the usual transversal weakened lines. In this case, depending on the ability of the user, as soon as a weakened line surpasses the plane of the wipe extracting and retaining window, said weakened line will be submitted to the pulling forces exerted by the user and may be torn immediately after surpassing the window plane, causing the inconvenience cited above.

Thus, the amount of the wipe strip extension to be left above the window after extracting a wipe will depend on the user's attention when he applies an abrupt pulling force onto the wipe strip, only when the chosen weakened line is at a certain distance outside said window.

Depending on the conditions of use and on the user's attention in relation to this operational characteristic, it will not be possible to maintain a remaining portion of the wipe strip outside the window, in order to serve as a grasping portion for the subsequent extracting operation.

Also in the known solutions, it should be noted that the stored wipes usually have weakened lines which limit the size of the wipe to be used and in a way impair certain the weakened line is not adequate.

### DISCLOSURE OF THE INVENTION

Thus, it is a general objective of the present invention to provide a cap for a dispensing container of wet wipes arranged in a continuous strip, which cap allows the user, by a simple and safe operation, to cut wipe portions, which are extracted from the container in a condition which always guarantees to maintain a certain extension of the wipe strip outside said cap and in the desired size.

The cap for the dispensing container of wet wipes arranged in a continuous strip is applied to a respective opening of the container and comprises, according to the present invention, an upper wall provided with a window, through which is extracted the wipe strip and whose contour is extended, at least on one of the sides, by a narrow slot for introducing and retaining the wipe strip, said upper wall carrying, externally, a cutting blade spaced away from the narrow slot, for cutting the transversal extension of the wipe strip when it is pressed against said cutting blade by the user.

With this new construction proposed above, the transversal cutting of the wipe strip will always be made in the region of the cutting blade, i.e., at a certain distance from the window, always guaranteeing the maintenance of a certain remaining extension of the wipe strip outside lie container, in order to make easier for the user to grasp another wipe in the following operation.

### BRIEF DESCRIPTION OF THE DRAWINGS

The invention will be described below, with reference to tho attached drawings, in which:

FIG. 1 is a perspective view of the cap in an open condition and mounted to a cylindrical tubular container, partially cut;

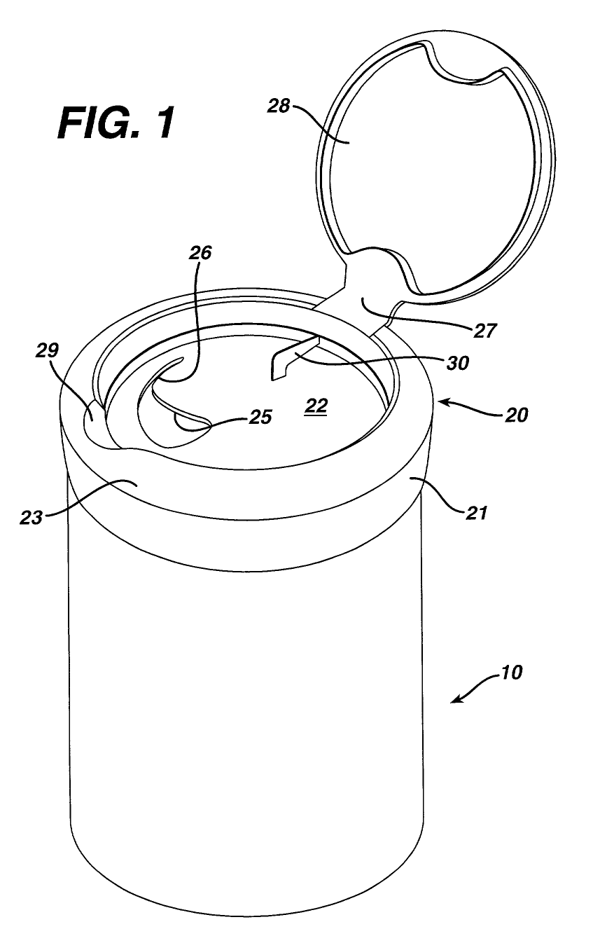

FIG. 2 is an upper plan view of the cap in the wide open condition; and

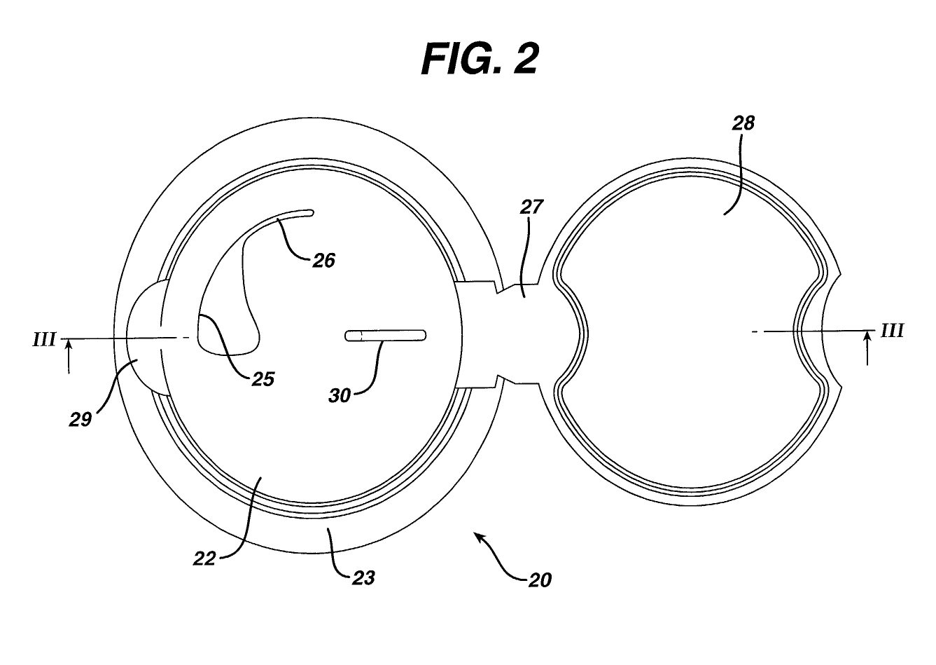

FIG. 3 is a cross-sectional view of the cap in the open condition, taken according to line III of FIG. 2.

### DESCRIPTION OF THE ILLUSTRATED EMBODIMENT

As illustrated in the attached drawings, the cap of the present invention is of the type which may be adapted, by threading or simple fitting, or any other fixation system, to the opening of a container 10, which in the illustrated example has a tubular cylindrical shape, with the lower end closed and with the upper end designed in order to receive, by fitting, the cap 20 of the present invention. In the illustrated embodiment, the upper end of the container 10 has a slight diametral reduction and is provided with a salient peripheral rib 11, whose function will be explained later. Inside the container 10 is stored a continuous wipe strip (not illustrated).

Still according to the illustrated embodiment, the cap 20 comprises a peripheral skirt 21 and an upper wall 22, which is recessed in relation to the upper peripheral edge 23 of said cap 20. In this constructive example, the peripheral skirt 21 is internally provided with a salient rib 24 seated below the rib 11 of the container 10, in order to promote the axial retention of the cap 20 in the upper end of the container 10. It should be understood, however, that both the upper end of the container 10 and the cap 20 may have different constructions, leading to the fixation by threading or by any other known or unknown adequate system, provided that it allows to obtain a preferably releasable locking of the cap 20 onto the open end of the container 10. It should also be understood that the container 10 ray have different regular or irregular prismatic shapes, or even take the form of a bag provided with an opening or inlet, to which the cap of tie present invention may be applied.

It should also be understood, within the scope of this invention, that the wipe strip stored inside the container may contain weakened lines defining between each other a respective wipe extension.

Independently of the shape applied to the cap 20, the latter has an upper wall 22, which may or may not be recessed in relation to the upper peripheral edge 23 of the cap 20 and which is provided with a window 25 with an adequate cross-sectional area to allow the manual extraction of the wipe strip from the inside of the container, the contour of said window 25 being extended, at least on one of its sides, by a narrow slot 26, which is dimensioned to receive therewithin, by being transversely displaced from the window 25, a respective transversal extension of the wipe strip, the width of the narrow slot being dimensioned in order to retain the wipe strip against axial displacement outwardly from the container when submitted to a pulling force by the user, and also having a longitudinal extension designed to receive the whole transversal extension of the wipe strip when the latter is transversaly displaced by the user from the window 23 to the inside of said narrow slot 26.

With this constructive arrangement of the window 25 associated with the narrow slot 26, it is possible for the user to pull a certain wipe strip extension out from the container, making said wipe strip slide axially through the window 25, until an adequate wipe extension has been obtained, which will be detached from the container, by the user transversely displacing said wipe strip to the inside of the narrow slot 26, where it will stay axially locked against displacements in relation to the cap 20 and subsequently cut, as described below.

The upper wall 22 of the cap 20 further carries, externally, a cutting blade 30, which is spaced from the narrow slot 26 so as to cut the transversal wipe strip extension when it is pressed against said blade by the user.

It should also be noted that the contour of the window 25 is designed to smoothly coincide with the contour of true narrow slot 26, so that :he wipe strip may flow smoothly through the window 25 when pulled by the user, facilitating the transversal displacement of the wipe strip to the inside of the narrow slot 26, without said displacement meeting any barrier against the transversal sliding of the wipe strip. Obviously, the contours of the window 25 and of the narrow slot 26 may have distinct shapes, as long as they allow both operations of axial and transversal displacements of the wipe strip, without submitting the latter to any efforts that might impair its structure.

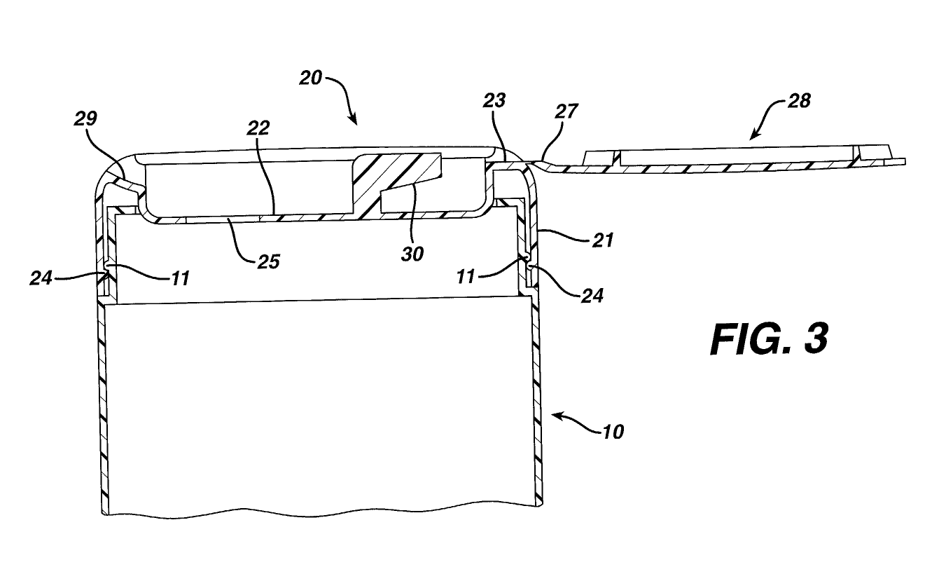

Also according to the illustrated embodiment, the cutting blade 30 is provided on a plane which is substantially orthogonal to the plane of the upper wall 22 of the cap 20, the cutting edge of said cutting blade 30 facing downwardly, i.e., towards the upper wall 22, maintaining from the latter a certain spacing sufficient to allow the wipe strip be introduced between said cutting edge and the upper wall 22 of the cap 20. Aiming at facilitating the cutting so the wipe strip, the cutting edge of the cutting blade 30 is preferably inclined in relation to the plane of the upper wall 22 of the cap 20, as better illustrated in FIG. 3.

Aiming at facilitating the construction of the cap 20 and protecting the user against accidents, the cutting blade 30 is laterally and superiorly covered by the material which forms the upper wall 22 of the cap 20, preferably molded in a single piece of injected plastic. Thus, the lateral and superior covering of the cutting blade 30 with the material of the cap 20 provides for an extremely simple fixation and a practically complete covering of the cutting blade 30 by a protective stainless material, usually plastic, leaving uncovered only the lower cutting edge of the cutting blade 30.

In the illustrated example, in which the upper wall 22 of the cap 20 is recessed in relation to the upper peripheral edge 23 of said cap 20, the total height of the cutting blade 30 is designed, so that the latter is contained below the plane defined by the upper peripheral edge 23 of the cap 20. However, it should be understood that other cap configurations may be obtained, independently of the upper wall 22 being leveled with the upper peripheral edge 23 and of the cutting blade being projected upwardly from the plane of said upper peripheral edge 23. In the illustrated embodiment, the cap 20 further incorporates, preferably in a single piece and through a small articulating tab 27, an overcap 28, which may be displaced from an open position, in which it exposes the upper wall 22 of the cap 20, and a closed position, not illustrated, in which it defines with said upper wall 22 a chamber for lodging the cutting blade 30 and the longitudinal wipe strip extension, which has been is already extracted and positioned between the window 25 and the cutting blade 30.

Regardless of the shape given to the container 10, the latter should be designed to store therewithin a wipe strip and avoid the contamination and drying of the wet wipes.

In the illustrated embodiment, in which the upper wall 22 is recessed in relation to the upper peripheral edge 23 of the cap 20, said upper peripheral edge is preferably provided with a small recess 29, diametrically opposite to the articulating tab 27, in order to facilitate the introduction of the user's finger upon displacing the overcap 28 from its closed to its open position.

We claim:

1. A cap for a container capable of dispensing a continuous strip of wet wipes comprising:
a) an upper wall provided with a window having a contour that is extended, at least on one of the sides of the window, by a narrow slot for introducing and retaining the strip, the upper wall further having a plane, and
b) a cutting blade provided externally on the upper wall and spaced away from the narrow slot for cutting a transverse extension of the strip when the strip is pressed against the cutting blade by the user.

2. The cap of claim 1, wherein the contour of the window coincides with the contour of the narrow slot such that the strip may flow smoothly through the window when pulled by the user.

3. The cap of claim 1, wherein the narrow slot has a width dimensioned to restrain the strip from axially displacing outwardly from the container when the strip is pulled by the user.

4. The cap of claim 1 wherein the narrow slot has a longitudinal extension dimensioned to receive a whole transverse extension of the strip.

5. The cap of claim 1, wherein the cutting blade is provided on a plane substantially orthogonal to the plane of the upper wall of the cap.

6. The cap of claim 5, wherein the cutting blade has a cutting edge facing the upper wall and slightly spaced therefrom, the cutting edge further comprising a lower cutting edge.

7. The cap of claim 6, wherein the cutting edge of the cutting blade is inclined in relation to the plane of the upper wall of the cap.

8. The cap of claim 6, wherein the cutting edge of the cutting blade is laterally and superiorly covered by a material that forms the upper wall of the cap such that only the lower cutting edge is uncovered.

9. The cap of claim 1, further comprising a peripheral edge concentrically integral with the upper wall, wherein the upper wall is recessed in relation the upper peripheral edge of the cap and the cutting blade is provided below the plane of the upper peripheral edge.

10. The cap of claim 1 further comprising a peripheral edge concentrically integral with the upper wall and an overcap attached to the peripheral edge, whereby the overcap is selectively displaceable between an open position that exposes the upper wall of the cap, and a closed position that defines a chamber for lodging the cutting blade and a longitudinal extension of the strip that has been already extracted and positioned between the window and the cutting blade.

11. The cap of claim 1, wherein the strip is provided with weakened lines.
